(19) United States
(12) Patent Application Publication
(10) Pub. No.: US 2025/0109615 A1
(43) Pub. Date: Apr. 3, 2025

(54) VEHICLE DOOR LATCH

(71) Applicant: Minebea AccessSolutions France, Alfortville (FR)

(72) Inventors: François DEBROUCKE, Alfortville (FR); Etienne THOLLON-POMMEROL, Alfortville (FR); Jean-Baptiste GRISLAIN, Alfortville (FR)

(73) Assignee: Minebea AccessSolutions France, Alfortville (FR)

(21) Appl. No.: 18/899,492

(22) Filed: Sep. 27, 2024

(30) Foreign Application Priority Data
Oct. 2, 2023 (EP) 23315376.6

(51) Int. Cl. E05B 81/90; E05B 77/34; E05B 79/20; E05B 81/04; E05B 81/14; E05B 85/02

(52) U.S. Cl. CPC E05B 81/90; E05B 79/20; E05B 81/04; E05B 81/14; E05B 85/02; E05B 77/34

(57) ABSTRACT

A vehicle door latch includes a casing including an opening to receive a striker in the closed position of the door, a rotatable hook disposed in the casing to get detachably engaged with the striker by rotating between closed and opened positions, a pawl mechanism disposed in the casing for moving between a blocking position wherein the pawl mechanism blocks the rotation of the rotatable hook and a release position, an electrical motor linked to the pawl for moving the pawl between its blocking and release positions, and a manual release mechanism including an actuator linked to the pawl mechanism and extending outside of the casing and including a lever that can be grabbed by a user to manually move the pawl mechanism between its blocking and release positions, the manual release mechanism can also block the actuator in the release or blocking position of the pawl mechanism.

### TECHNICAL FIELD

The present invention relates to the field of vehicle door latches to control the locking of vehicle doors and in particular to electrical latches.

### BACKGROUND OF THE INVENTION

Electrical latches are widely used in the automotive industry to provide security and comfort to the users. Such electrical latches comprise an electrical motor powered by a battery of the vehicle. With such electrical latches, the door is unlocked upon reception of an electrical signal which is transmitted by the handle upon detection or actuation of a user or by a remote device.

In order to ensure users safety, it is necessary to foresee a back-up manual mechanism in case of misfunctioning of the electrical latch for example in case of power shortage especially for users located inside the vehicle.

With the back-up manual mechanisms of the state of the art, it is usually required to disassemble the latch to bring it back to its normal functioning (via the electrical motor) after the misfunctioning is fixed.

However, as the misfunctioning of the electrical latch may be fixed rapidly and easily, for example in case of a power shortage, it is only required to charge the battery so that it may be useful to have a back-up manual mechanism which is easily reversible by the user without requiring cumbersome handlings or the intervention of a maintenance technician.

The present invention aims therefore at providing an electrical latch comprising a back-up manual mechanism which is easily reversible.

### SUMMARY OF THE INVENTION

The present invention refers to a vehicle door latch comprising:
a casing configured to be arranged on a door of a vehicle and comprising an opening configured for receiving a striker in the closed position of the door, the striker being arranged on a vehicle body,
a rotatable hook disposed in the casing and configured to get detachably engaged with the striker by rotating between a closed position and an opened position,
a pawl mechanism disposed in the casing and configured for moving between a blocking position wherein the pawl mechanism blocks the rotation of the rotatable hook and a release position,
an electrical motor linked to the pawl mechanism and configured for moving the pawl mechanism from its blocking position to its release position and conversely,
a manual release mechanism comprising actuation means linked to the pawl mechanism and extending outside of the casing and comprising a lever that can be grabbed by a user to manually move the pawl mechanism from its blocking position to its release position and conversely, the manual release mechanism also comprising blocking means for blocking the actuation means in the release position or in the blocking position of the pawl mechanism.

Such vehicle door latch enables providing a manual release mechanism which can easily be used by a user in case of failure of the electric part of the latch and which is reversible to manually unlock or lock the door with ease and which can be easily blocked in the lock or the unlock position by the user.

According to another aspect of the present invention, the lever is pulled by the user to move the pawl mechanism from its blocking position to its release position and is pushed by the user to move the pawl mechanism from its release position to its blocking position.

According to another aspect of the present invention, the actuation means comprise a rod linked to the pawl mechanism and extending outside of the casing.

According to another aspect of the present invention, the actuation means comprise a Bowden cable linked to the pawl mechanism and extending outside of the casing.

According to another aspect of the present invention, the blocking means comprise an elastic part configured to be compressed by the casing to block the displacement of the actuation means in the release position of the pawl mechanism.

According to another aspect of the present invention, the blocking means comprise a clamp configured for hooking on the casing in the release position of the pawl mechanism.

According to another aspect of the present invention, the casing comprises an additional opening through which the actuation means extend outside of the casing and wherein an umbrella or a water guiding dropper is arranged on a part of the actuation means adjacent to the additional opening to provide waterproofness.

According to another aspect of the present invention, the casing comprises an additional opening through which the actuation means extend outside of the casing wherein the additional opening has a shape of a hollow cylinder and wherein the actuation means comprise a cylindrical part which is complementary with the hollow cylinder and which is configured to be introduced within the hollow cylinder in the blocking position of the pawl mechanism to provide waterproofness.

According to another aspect of the present invention, the casing comprises an additional opening through which the actuation means extend outside of the casing wherein the additional opening comprise a flexible part associated with a narrow section and wherein the actuation means comprise a slider with cams, the slider being configured for deforming the flexible part when the slider is slid within the narrow section.

According to another aspect of the present invention, the vehicle door latch also comprises elastic means, such as a return spring, configured for constraining the pawl mechanism in its blocking position.

The present invention also refers to a vehicle door comprising a vehicle door latch as described previously.

According to another aspect of the present invention, the vehicle door comprises a housing arranged next to the latch and closed by a flap arranged on the inner side of the door and wherein the lever is disposed in the housing.

The present invention also refers to a vehicle comprising a vehicle door as described previously.

### BRIEF DESCRIPTION OF THE DRAWINGS

FIG. 1 is a schematic view of a vehicle door latch according to the present invention;

FIG. 2 is a perspective view of a vehicle door latch according to another embodiment of the present invention;

FIG. 3 is a side view of a manual release mechanism of the vehicle door latch of FIG. 2;

FIG. 4 represents a manual release mechanism according to an embodiment of the invention in a blocking position of the pawl mechanism;

FIG. 5 represents the manual release mechanism of FIG. 4 in a release position of the pawl mechanism;

FIG. 6 represents the manual release mechanism of FIG. 4 blocked in a release position of the pawl mechanism;

FIG. 7 represents the manual release mechanism of FIG. 4 unblocked from the release position of the pawl mechanism;

FIG. 8 represents blocking means according to an embodiment of the present invention in a first position;

FIG. 9 represents blocking means of FIG. 8 in a second position;

FIG. 10 represents blocking means of FIG. 8 in a third position;

FIG. 11 represents a perspective view of an umbrella arranged on actuation means of a manual release mechanism;

FIG. 12 represents a perspective view of a water guiding dropper arranged on actuation means of a manual release mechanism;

FIGS. 13 and 14 represent a perspective view of alternative embodiment of the actuation means of the vehicle door latch;

FIG. 15 represents a side view of the actuation means of FIG. 13;

FIGS. 16 to 19 represent side views of a further embodiment of a vehicle door latch in different positions of the actuation means of the manual release mechanism.

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

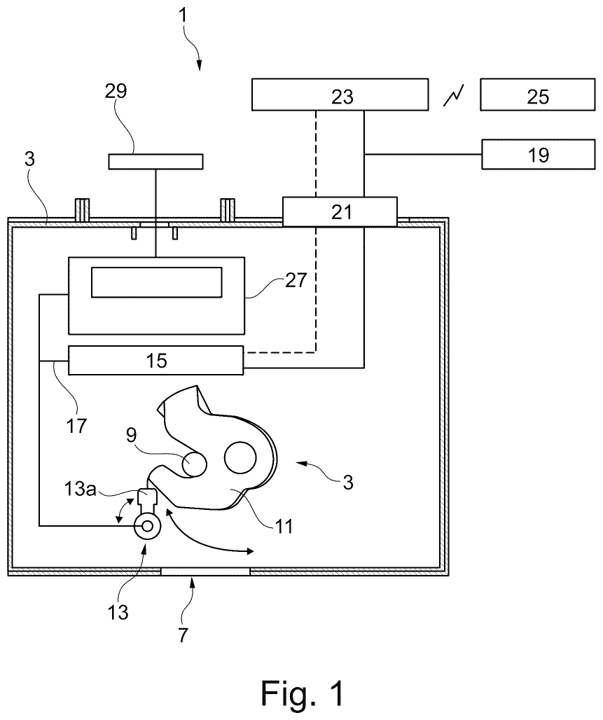

The present invention refers to a vehicle door latch and in particular an electrical door latch to lock or unlock a vehicle door. The term “door” herein means a passenger door or a trunk lid or a tailgate. As represented in FIG. 1, the latch 1 comprises a casing 3 configured to be arranged on a door of a vehicle and surrounding the latch mechanism 5. An opening 7 is arranged in the casing 3 to enable the introduction of a striker 9 arranged on the vehicle body when the door is in a closed position.

The latch mechanism 5 comprises a rotatable hook 11 configured to get detachably engaged with the striker 9 by rotating between a closed position blocking a relative displacement between the latch 1 (and therefore the door) and the striker 9 (as represented in FIG. 1) and an opened position. The rotation of the rotatable hook 11 may be controlled by a handle linked to the rotatable hook 11 by a Bowden cable (not represented) or via an electrical motor connected to the handle.

The latch mechanism 5 also comprises a pawl mechanism 13 arranged next to the rotatable hook 11. The pawl mechanism 13 may comprise a pawl 13a and an opening lever 13b and is configured for moving between a blocking position wherein the pawl mechanism 13 blocks the rotation of the hook 11 and a release position. The movement of the pawl mechanism 13 may be a rotation as represented in FIG. 1. The positions of the pawl mechanism 13 and the hook 11 in FIG. 1 correspond to a locked position of the door. From this position, the pawl mechanism 13 may be rotated counterclockwise towards its release position. The hook 11 may then be rotated counterclockwise towards its opened position. The striker 9 may then be separated from the latch mechanism 5 through the opening 7 of the casing 3.

The latch mechanism 5 also comprises an electrical motor 15 linked to the pawl mechanism 13 via a driving force mechanism 17 comprising for example a shaft, a lever, a gear, a cam or the like thereby forming a power transmission path for transmitting rotational torque to the pawl mechanism 13. The electrical motor 15 is therefore configured for moving the pawl mechanism 13 from its blocking position to its release position and conversely. The electrical motor 15 may be driven in forward and reverse directions. The electrical motor 15 may be powered by a battery 19 of the vehicle via connectors 21 arranged on the casing 3. The electrical motor 15 may be driven by a controller 23 upon reception of a signal transmitted by a remote control 25 to lock or unlock the latch 1. The controller 23 may be a computer with a central processing unit (CPU), a memory and input/output interfaces. The remote control 25 may comprises a smart key with a button switch, a door lock switch provided on the door and any known remote control. The remote control 25 may also be connected to the controller 23 by wire. The controller 23 may also be arranged within the casing 3. The controller 23 may also be powered by the battery 19 of the vehicle.

The latch mechanism 5 also comprises a manual release mechanism 27 comprising actuation means linked to the pawl mechanism 13 for example to the opening lever 13b of the pawl mechanism 13. The manual release mechanism 27 extends outside of the casing 3 through an additional opening 8 and comprises a lever 29 that can be grabbed by a user to manually move the pawl mechanism 13 from its blocking position to its release position and conversely.

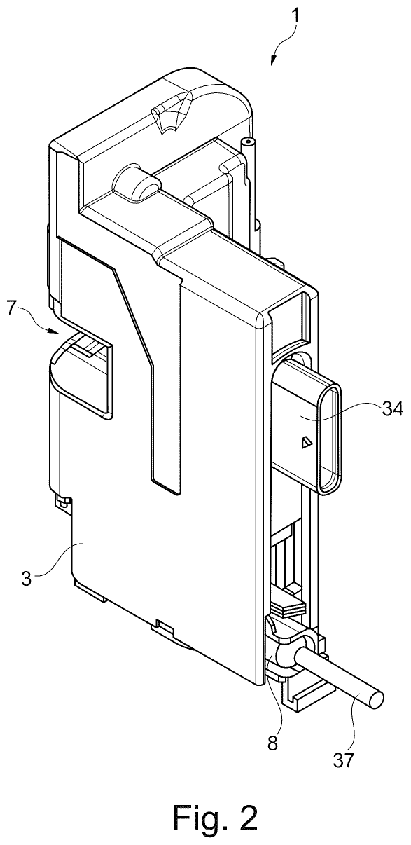

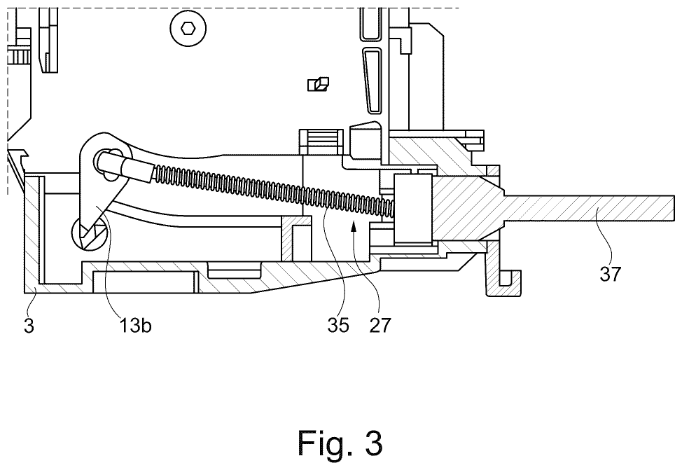

According to an embodiment represented in FIGS. 2 and 3, the manual release mechanism 27 comprises a Bowden cable 35 linked at one end to the pawl mechanism 13, for example to the opening lever 13b of the pawl mechanism 13 and at the other end to the lever 29. A sheath 37 may be arranged around the Bowden cable 35, notably for the part of Bowden cable 35 located outside of the casing 3.

According to another embodiment not represented, the manual release mechanism 27 may comprise a rotatable lever 29 which is rotated in a first direction to rotate the pawl mechanism 13 from its blocking position to its release position and in a second direction, opposite to the first direction, to rotate the pawl mechanism 13 from its release position to its blocking position for example via the opening lever 13b of the pawl mechanism 13.

The actuation means of the manual release mechanism 27 may also comprise a shaft, a gear, a cam or the like to ensure the force transmission between the lever 29 and the pawl mechanism 13. Some of these actuations means may be shared with the driving force mechanism 17 associated with the electrical motor 15.

The manual release mechanism 27 also comprises blocking means for blocking the actuation means, herein the rod 31 or the Bowden cable 35, in the release position of the pawl mechanism 13. The pawl mechanism 13 may be constrained in its blocking position by elastic means such as a return spring. In such case, the blocking means provide a force, such as a friction force, high enough to overcome the force applied by the elastic means.

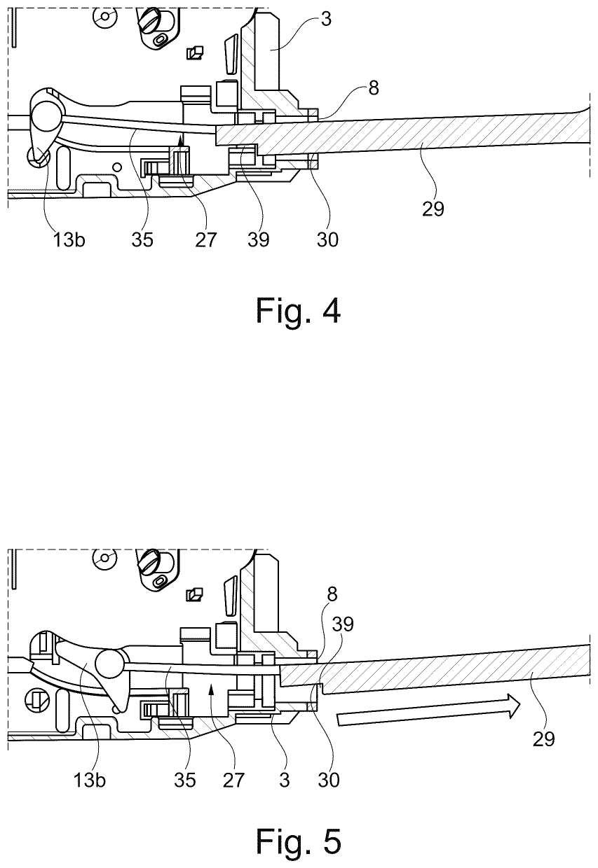

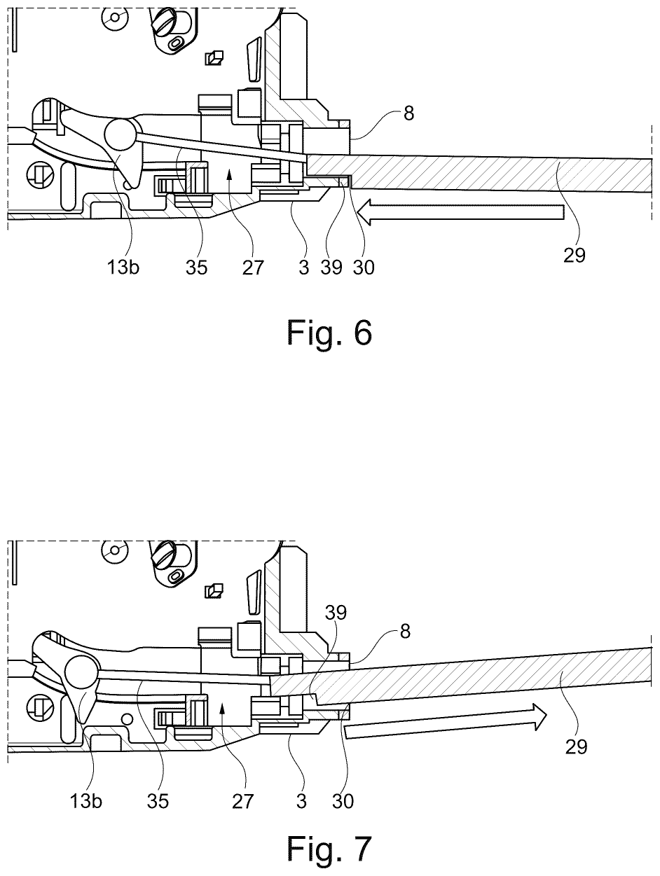

According to an embodiment represented in FIGS. 4 to 7, the blocking means comprise a clamp 39 which may be arranged in the lever 29. The clamp 39 is configured for hooking on an edge 30 of the casing 3 in the release position of the pawl mechanism 13 as represented in FIG. 6. The clamp 39 may be formed by a corner arranged in the lever 29. Thus, FIG. 4 represents the pawl mechanism 13 in the blocking position. Preferably, the clamp 39 is still in the casing 3 at this time. FIG. 5 represents the displacement of the manual release mechanism 27 upon pulling of the user on the lever 29 leading to the rotation of the pawl mechanism 13 towards its release position. Preferably, the clamp 39 thereby moves from the inside of the casing 3 to the outside of the casing 3 and can also be outside of the casing 3 at this time. FIG. 6 represents the blocking of the manual release mechanism in the release position of the pawl mechanism 13 by hooking the clamp 39 on the edge 30 of the casing 3. FIG. 7 represents the release of the blocking means by pulling the lever 29 again and unhooking the clamp 39 from the edge 30 of the casing 3. The pawl mechanism 13 may then be brought back into the blocking position by pushing on the lever 29 towards the casing 3. Preferably, to unhook the clamp 39, the lever 29 is pulled again, which releases the clamp 39 from the housing and allows the lever 29 to be brought back into the blocking position by pushing the lever 29 towards the inside of the casing 3.

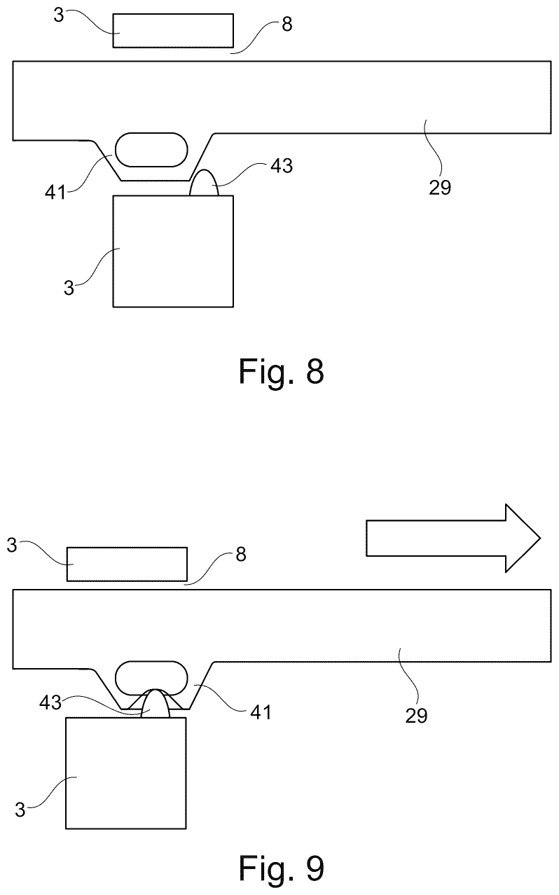

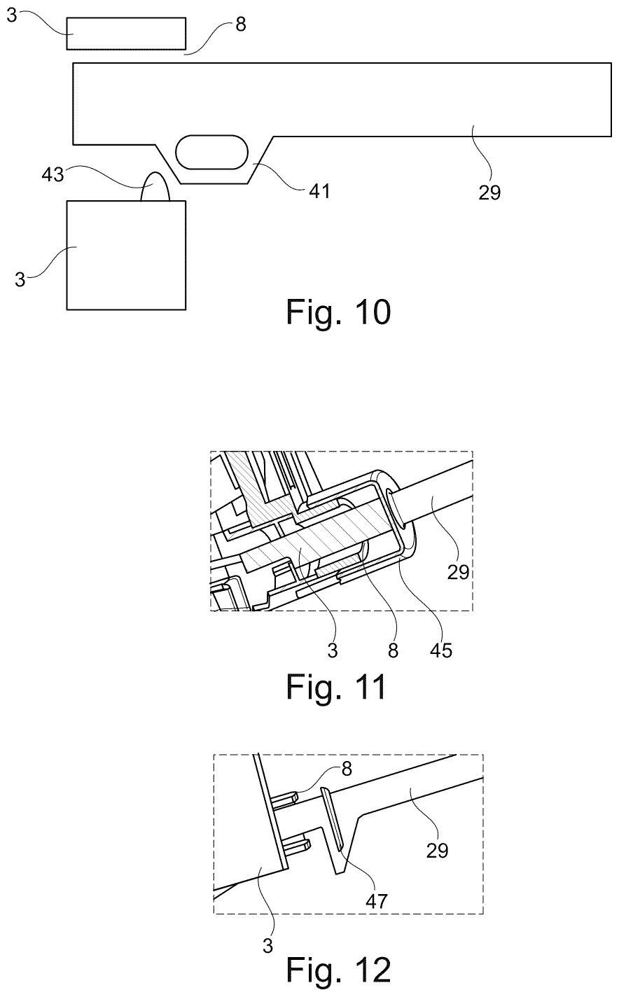

According to another embodiment represented in FIGS. 8 to 10, the blocking means comprise an elastic part 41 configured to be compressed elastically by the casing 3, for example by a pin 43 arranged in the casing 3. The elastic part 41 may be arranged on the lever 29. Alternatively, the elastic part may be arranged in the casing 3 and compressed by a pin arranged on the lever 29. The elastic deformation of the elastic part 41 due to its compression produces a huge friction force and blocks the displacement of the actuation means, for example the rod 31 or the Bowden cable 35, in the release position of the pawl mechanism 13. FIG. 8 represents the position of the lever 29 when the pawl mechanism 13 is in the blocking position. FIG. 9 represents the position of the lever 29 when the user pulls on the lever 29 to rotate the pawl mechanism 13 towards its release position by overcoming the friction force produced by the elastic part 41 and FIG. 10 represents the position of the lever 29 when the pawl mechanism 13 is in the release position. The combination of the elastic part 41 and the pin 43 of the casing 3 prevents the lever 29 from being moved back towards the pawl mechanism 13 and therefore prevents the pawl mechanism 13 from rotating back to its blocking position when no force is applied by the user on the lever 29. By pushing the lever 29 towards the casing 3, the user may overcome the friction force between the elastic part 41 and the casing 3 and may therefore lead to the rotation of the pawl mechanism 13 back to its blocking position.

Thus, the blocking means enable blocking the pawl mechanism 13 in its blocking or in its release position depending on the action of the user on the lever 29. These blocking means may be applied on the embodiment presented in FIGS. 2 and 3.

The casing 3 may also comprise an equipment to prevent water from entering the casing 3 in the additional opening 8 through which the manual release mechanism 27 or the lever 29 extends outside of the casing 3. Such equipment may refer to an umbrella 45 arranged on the actuation means, in particular on the part adjacent to the additional opening 8 to provide waterproofness as represented in FIG. 11. The umbrella 45 surrounds the actuation means such as the lever 29 and covers the additional opening 8 when the pawl mechanism 13 is in its blocking or release position. Alternatively, it may refer to a water guiding dropper 47 arranged on the actuation means, herein the lever 29, to prevent droplets from entering the casing 3 as represented in FIG. 12.

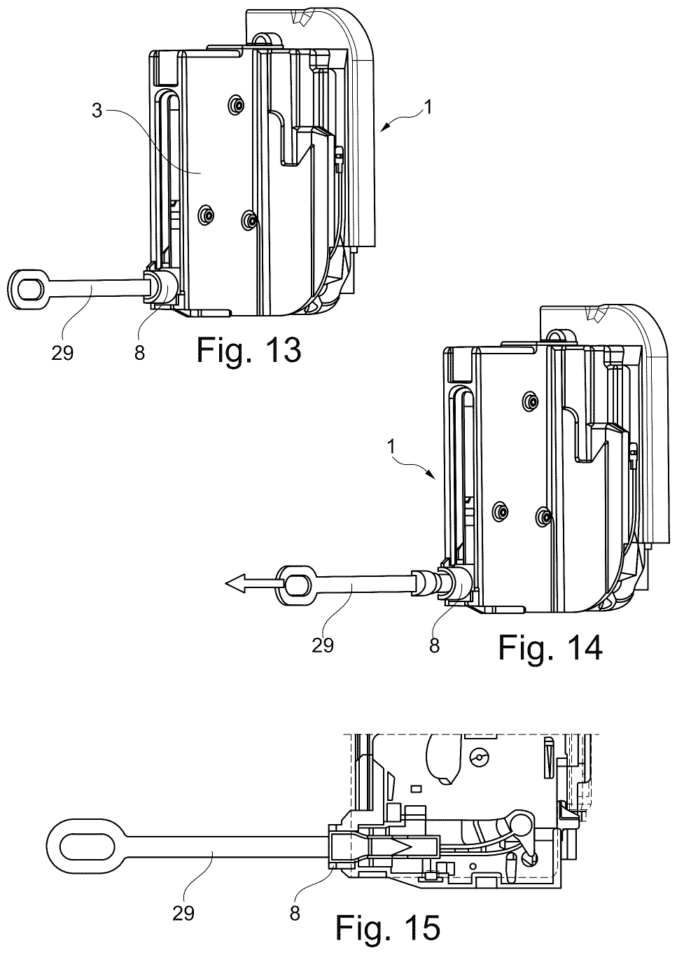

According to another embodiment represented in FIGS. 13 to 15, the casing 3 comprises an additional opening 8 through which the actuation means, in particular the lever 29, extend outside of the casing 3. The additional opening 8 has a shape of a hollow cylinder and the actuation means comprise a cylindrical part which is complementary with the hollow cylinder of the additional opening 8. In the blocking position of the pawl mechanism 13, the cylindrical part is introduced within the hollow cylinder as presented in FIG. 13. Such configuration provides waterproofness. The functioning of the latch 1 is otherwise similar to the previous embodiment so that the user pulls on the lever 29 to lead the pawl mechanism 13 towards its release position as represented in FIG. 14.

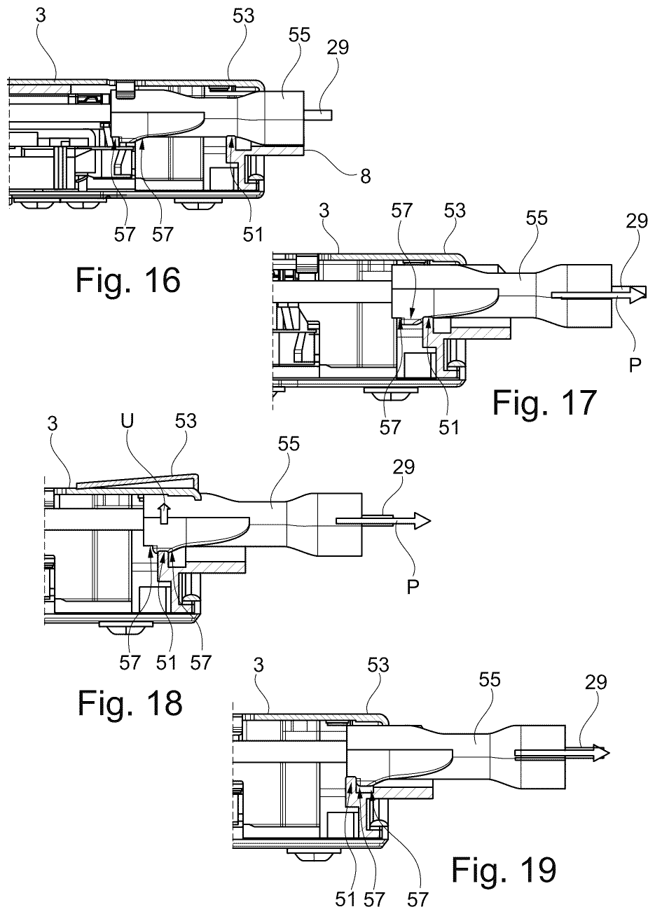

According to another embodiment of the blocking means represented in FIGS. 16 to 19, the casing 3 comprises an additional opening 8 through which the actuation means extend outside of the casing 3. The additional opening 8 may have a cylindrical shape. The additional opening 8 comprises a narrow section 51 and a flexible part such as a flexible hood 53 associated with the narrow section 51 so that a deformation of the flexible hood may enlarge the narrow section 51. The narrow section 51 may be achieved by a wall as represented in FIG. 16. The actuation means comprise a slider 55 configured for sliding within the additional opening 8 when the lever 29 is pulled or pushed by the user. The slider comprises cams 57 to overcome the narrow section 51 by deforming the flexible hood 53 when the lever 29 is slid through the narrow section 51 as represented in FIG. 18. The cams 57 are made by opposite slopes to produce a ramp up and a ramp down. The cams 57 enables the slider to pass through the narrow section 51 when pulled or pushed by the user thanks to the deformation of the flexible hood 53. The cams 57 are positioned on one side of the slider 55, in the present case at the bottom side and the flexible hood 53 is located on the other side, in the upper side in the present case. Thus, when the lever 29 is pulled as represented by the arrow P in FIGS. 17 and 18, a first cam 57 of the slider 55 produces a movement of the slider 55 towards the flexible hood 53 which is displaced or deformed upside as represented by the arrow U in FIG. 18. The deformation of the flexible hood 53 enables the slider 55 to overcome the wall forming the narrow section 51 to reach a stop corresponding to the release position of the pawl mechanism 13 as represented in FIG. 19. In this position, the flexible hood 53 is brought back in its original position due to its elasticity and flexibility. A second cam 57 opposed to the first cam 57 enables the slider 55 to slide in the opposite direction and to overcome the narrow section 51 when the lever 29 is pushed back towards the blocking position of the pawl mechanism 13.

Thus, in a normal functioning, the pawl mechanism 13 is rotated between its blocking and its release position by the electrical motor 15 to lock or unlock the latch 1 and enable or not the opening of the door through the rotation of the hook 11. The electrical motor 15 being driven by a controller 23. The controller 23 may communicate with a remote control 25 handled by the user.

In case of failure or misfunctioning of the electrical motor 15 (or one of the elements used to control the electrical motor 15) for example due to a power shortage, a user located inside the vehicle may access the lever 29 of the manual release mechanism 27, for example by opening a flap of a housing enclosing the lever 29. The user may then pull on the lever 29 to rotate the pawl mechanism 13 from its blocking position to its release position to manually unlock the latch 1. The pawl mechanism 13 may then be blocked in the release position due to the blocking means, for example the elastic part 41 which is compressed by the casing 3. As the latch 1 is unlocked, the user may open the door, for example by pulling a handle linked to the rotatable hook 11. The user may then get a device to fix the failure, for example a charger to charge the battery 19. As the pawl mechanism 13 is maintained in the release position, the user may leave the vehicle and come back later with a fixing device such as a charger and may still enter the vehicle. After having fixed the failure, for example after having charged the battery 19 of the vehicle, the user may bring the pawl mechanism 13 back in the blocking position by pushing on the lever 29 with a force exceeding the friction force required to reintroduce the elastic part 41 inside the casing 3.

Thus, the vehicle door latch according to the present invention enables providing an electrical latch 1 with a manual release mechanism 27 which is easy to handle by the user, which is easily reversible and which enables a stable position in a locked or an unlocked position of the latch 1 in case of failure of the electric part of the latch 1.

1-13. (canceled)

14. A vehicle door latch, comprising:
a casing configured to be arranged on a door of a vehicle and comprising an opening configured to receive a striker in the closed position of the door, the striker being arranged on a vehicle body;
a rotatable hook disposed in the casing and configured to get detachably engaged with the striker by rotating between a closed position and an opened position;
a pawl mechanism disposed in the casing and configured to move between a blocking position wherein the pawl mechanism blocks the rotation of the rotatable hook and a release position;
an electrical motor linked to the pawl mechanism and configured to move the pawl mechanism from the blocking position to the release position and conversely; and
a manual release mechanism comprising actuation means linked to the pawl mechanism and extending outside of the casing and comprising a lever that is configured to be grabbed by a user to manually move the pawl mechanism from the blocking position to the release position and conversely, the manual release mechanism also comprising blocking means for blocking the actuation means in the release position or in the blocking position of the pawl mechanism.

15. The vehicle door latch in accordance with claim 14, wherein the lever is configured to be pulled by the user to move the pawl mechanism from the blocking position to the release position and is pushed by the user to move the pawl mechanism from the release position to the blocking position.

16. The vehicle door latch in accordance with claim 14, wherein the actuation means comprise a rod linked to the pawl mechanism and extending outside of the casing.

17. The vehicle door latch in accordance with claim 14, wherein the actuation means comprise a Bowden cable linked to the pawl mechanism and extending outside of the casing.

18. The vehicle door latch in accordance with claim 14, wherein the blocking means comprise an elastic part configured to be compressed by the casing to block the displacement of the actuation means in the release position of the pawl mechanism.

19. The vehicle door latch in accordance with claim 14, wherein the blocking means comprise a clamp configured to hook on the casing in the release position of the pawl mechanism.

20. The vehicle door latch in accordance with claim 19, wherein the casing comprises an additional opening through which the actuation means extend outside of the casing and wherein an umbrella or a water guiding dropper is arranged on a part of the actuation means adjacent to the additional opening to provide waterproofness.

21. The vehicle door latch in accordance with claim 14, wherein the casing comprises an additional opening through which the actuation means extend outside of the casing, wherein the additional opening has a shape of a hollow cylinder, and wherein the actuation means comprise a cylindrical part which is complementary with the hollow cylinder and which is configured to be introduced within the hollow cylinder in the blocking position of the pawl mechanism to provide waterproofness.

22. The vehicle door latch in accordance with claim 14, wherein the casing comprises an additional opening through which the actuation means extend outside of the casing, wherein the additional opening comprise a flexible part associated with a narrow section, and wherein the actuation means comprise a slider with cams, the slider being configured to deform the flexible part when the slider is slid within the narrow section.

23. The vehicle door latch in accordance with claim 14, further comprising elastic means for constraining the pawl mechanism in the blocking position.

24. A vehicle door, comprising:
the vehicle door latch in accordance with claim 14.

25. The vehicle door in accordance with claim 24, wherein the vehicle door comprises a housing arranged next to the latch and closed by a flap arranged on the inner side of the door and wherein the lever is disposed in the housing.

26. A vehicle, comprising:
the vehicle door in accordance with claim 24.
